(19) United States
(12) Patent Application Publication
(10) Pub. No.: US 2018/0146347 A1
(43) Pub. Date: May 24, 2018

(54) SMS NOTIFICATION SOFTWARE

(71) Applicant: RMC Pharmaceutical Solutions, Inc., Longmont, CO (US)

(72) Inventors: Scott Rudge, Boulder, CO (US); Korben Knudson, Denver, CO (US)

(21) Appl. No.: 15/581,874

(22) Filed: Apr. 28, 2017

Related U.S. Application Data
(60) Provisional application No. 62/320,782, filed on Apr. 11, 2016.

(51) Int. Cl. H04W 4/12; H04W 68/00

(52) U.S. Cl. CPC H04W 4/12; H04W 68/005

(57) ABSTRACT

Software that is able to detect a signal being passed from equipment to a computer, capture that signal and turn it into a message that is transmitted to an end user.

### FIELD OF THE INVENTION

The current technology relates to the field of notification software. More specifically, it relates to software that monitors data on a machine and sends SMS messages to selected devices.

### BACKGROUND

SMS messages (also referred to as text messages) are frequently used to notify “push” information to selected recipients. Laboratory equipment has not typically pushed information, but rather relies on the use to make frequent checks of the equipment's status, either on-site, or via a remote login. Here we describe the first software that independently resides on a computer that controls a piece of equipment and monitors the equipment's status, and then can notify users or other interested parties of status changes with that equipment.

### SUMMARY

This invention is designed to connect laboratory equipment with its users remotely and passively. Typically lab equipment runs with direct monitoring by the user. This is labor intensive and not cost effective. Most of the time, lab equipment runs without errors, but the occasional error will shut the equipment down and requires user intervention to restart. Since equipment shut down is usually costly in terms of repeat work, this invention connects the equipment to the user such that equipment status can be communicated directly and remotely to the user, without the user having to intervene directly or intentionally.

### BRIEF DESCRIPTION OF THE DRAWINGS

FIG. 1 shows the general concept embodied by the invention.

FIG. 2 shows a simplified version of the communication between the AKTA™ system 12 and computer with UNICORN™ software 10. Data is constantly being updated and shared between the two systems 10 and 12.

FIG. 3 shows the Event Processor system. The Event Processor monitors a folder 16 for a certain type of file within the folder 16. The folder to be monitored 18 is specified by the user. The file types 20 are already specified within the Event Processor. When a new file appears, the Event Processor checks for a match between the new file and a specified file type 22. If the new file is a type that does not match a specified file type the file is ignored 26; otherwise, the Tailer 24 is initiated and the file is sent to the Tailer 24.

FIG. 4 illustrates the Tailer system. It scans the file from the Event Processor 16 for certain data strings. The Tailer holds onto the file and reads the first data entry 28. Similarly to the Event Processor, data entry types are already specified within the Tailer 30 and can be configured by the user. If the first data entry type matches a specified data entry type, then the Parser 34 is initiated and the data entry is sent to the Parser 34. If the data entry type is not a match for a specified data entry type 30, then the file is released for a specified amount of time. After the period of time terminates, the next data entry type is read 36. A process similar to the first data entry occurs for all subsequent data entries 38, 40, 42.

FIG. 5 illustrates the Parser. The Parser receives the data entry from the Tailer 44 and reads through its content 46. The list of events 48, which is now synonymous with the terms “data” and “data entries”, is a list of specified events which warrants a notification. For example, a high pressure alarm in the ÄKTA is one of many specified events. The Parser reads each data entry for a match with any specified event 50. If a match does not occur, the entry is ignored 56 and the Parser waits for the next data entry from the Tailer 44. If a match does occur then the parser sends a job 54 to a third-party web service which commands the web service to send a text message in a certain format containing the information from the data entry to the list of phone numbers entered by the user 52. The method of the third-party web service is outside of the scope of this invention.

### DETAILED DESCRIPTION

This invention is designed to connect laboratory equipment with its users remotely and passively. Typically lab equipment runs with direct monitoring by the user. This is labor intensive and not cost effective. Most of the time, lab equipment runs without errors, but the occasional error will shut the equipment down and requires user intervention to restart. Since equipment shut down is usually costly in terms of repeat work, this invention connects the equipment to the user such that equipment status can be communicated directly and remotely to the user, without the user having to intervene directly or intentionally.

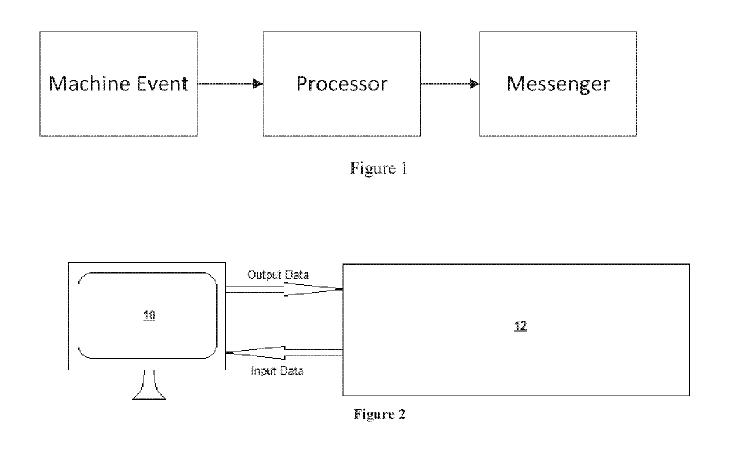

There are many technologies for pushing notifications to a user. Smart phone applications that reside on the phone can push notifications that are sent by a central server and allowed by the user. Twitter can broadcast thoughts and ideas from selected channels via the internet. SMS messages can be programmed to reach many users, again provided that they have authorized the communication. The basic structure of the invention consists of three modules, as shown in FIG. 1.

The SMS message is the most easily accessible and ubiquitous form of passive communication currently available. It is automatable and virtually instantaneous. SMS can be sent over a phone connection or an internet connection. The SMS messages do not depend on the platform possessed by the user, iOS, Windows and Android all accept SMS messages, as well as older mobile technologies that lack operating systems. SMS only relies on having a cellular signal, it does not require an internet connection. Therefore, this technology has relied exclusively on SMS for proof of concept.

Lab equipment has become increasingly complex, and experiments have become increasingly long. Most equipment in the lab is computer controlled and monitored. The computer sends instructions to the equipment, and the equipment sends data back to the computer. This relation is shown in FIG. 2. Typically, there is a log of events that is kept by the computer. The signals that create this log, or the log itself, can be useful for use as a basis for pushing a message to a remote user. However, other signals generated by the equipment or the computer could be envisioned as useful for capture and communication. In order to access the signals, the processor requires an Event Processor and a Tailer function.

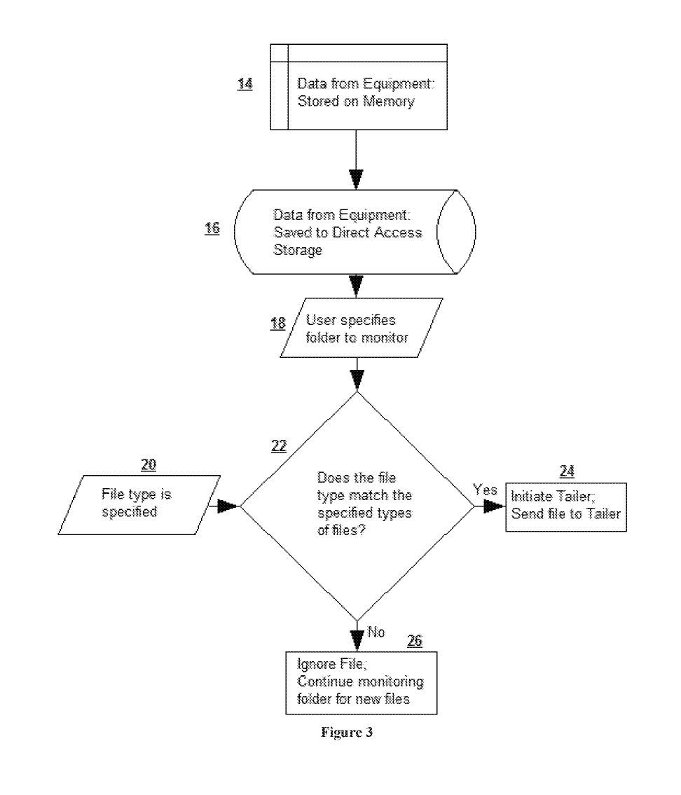

The Event Processor monitors the equipment for an event signal. This may take the form of the changing of an error bit from 0 to 1. It may also take the form of a string of characters being broadcast over a specific analog address. An event may also be shown by the change in a file like an event log that is kept by the computer. The Event Processor recognizes these signals and identifies the possibility of an event. An example of an Event Processor algorithm is shown in FIG. 3.

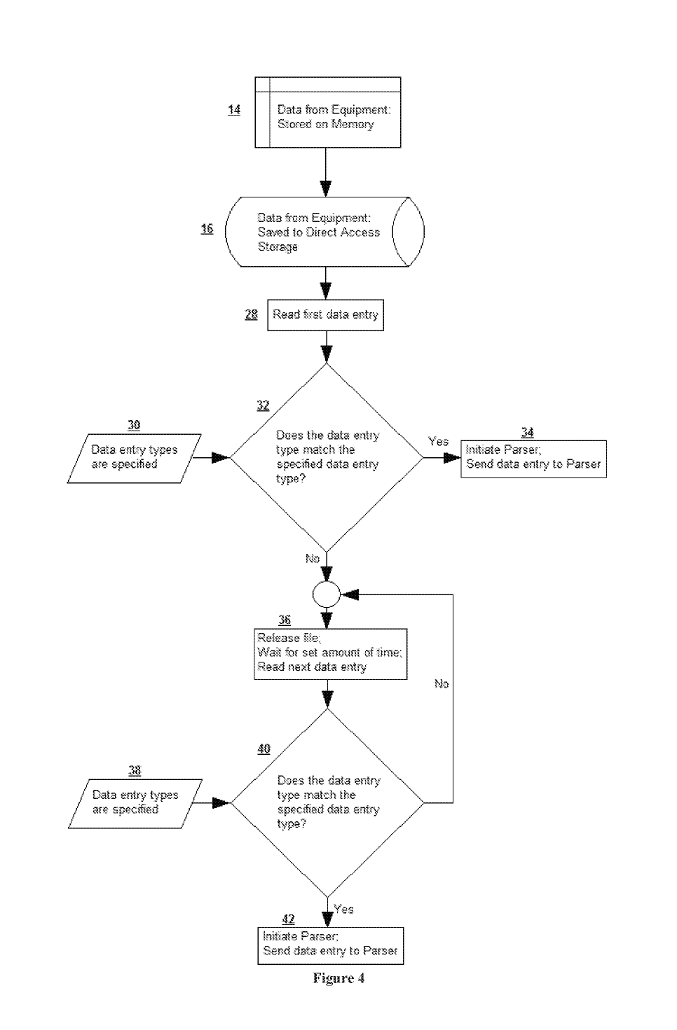

The Tailer can determine if the events identified by the Event Processor are real. The Tailer compares events to a list of codes to determine if there is a match. The codes may be fixed in the software, or can be user configured. A Tailer might also monitor multiple files in a specific location or directory, and determine any changes made to any of the files located therein. The Tailer function need not be integrated into the operating software for the computer or the equipment, it can reside as a separate software module. The Tailer's function is to identify all data that might constitute a signal to be sent to the user. An example of a Tailer algorithm is shown in FIG. 4.

There is copious information generated by most equipment/computer combinations, not all of it is readable by humans, and of the subset readable by humans, a further subset is relevant. In order to be useful, a processor of the information must be able to sort the information on a variety of factors, for example:
Is the information recent?
Does the information relate to a change in status of the equipment/computer?
Is the information routine or exceptional?
Is the information redundant?

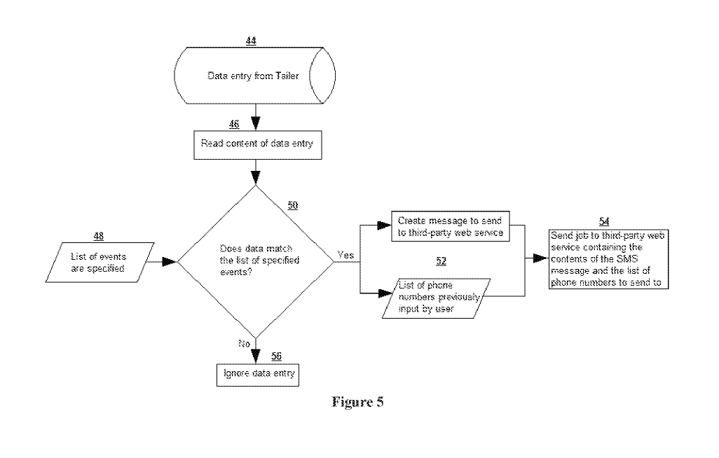

In order to extract the useful information, the processor needs a parsing function that can sort this data. The Parser can work on key words or phrases, or a set of specified events can be created. These specified events can be identified by machine code numbers or other identifiers. An example of a Parser algorithm is shown in FIG. 5.

Useful information can be defined or configured by the user, or it may be fixed by the coding.

Useful information, once identified by the parsing function, is packaged for a communication. Communication may be by SMS, by internet through email or a third party platform, such as Twitter, or by pager or phone call with pre-recorded messages. The processor takes the information identified by the Parser and translates it if necessary into a message understandable by the user. The message is then sent to the end user via a pathway identified above. When sending the message, the Messenger may be configured to communicate directly with the end user, or may use a third party platform.

### Example 1

A computer controls a piece of laboratory equipment through digital and analog input/output modules. One digital input address is identified as an error bit. A software program is designed to monitor the address of this bit, and to identify when the bit is switched to 1, indicating an error. The software requires the bit to be set to 1 for 20 consecutive scans before an error message is generated and sent to an end user.

### Example 2

In example 1, there are multiple end users, who have been identified with separate addresses at the initiation of the software.

### Example 3

In example 2, the addresses of the users are phone numbers, and the message is an SMS or text message.

### Example 4

In examples 1, 2 and 3, the addresses are email addresses, and the message is an email.

### Example 5

A Windows based computer running UNICORN software (GE Health Care Life Sciences, Marlborough, Mass.) controlling an AKTA preparative chromatography unit (GE Health Care Life Sciences, Marlborough, Mass.) records events in an events log. A software program is designed to open this event log 5 times per second and identify changes to the file. When changes are identified, the software compares the changes to a list of event codes that have been selected by the user. If an even matches, a message corresponding to that event is generated and transmitted to a third party provider, along with a list of phone numbers. The third party provider converts the message into a text. The third party provider then transmits the message as a text message to the list of phone numbers.

### Example 6

In example 5, the third party provider is Twilio.

### Example 7

In example 5, the message is posted as a “tweet” on the third party provider Twitter. End users are notified because they have subscribed to the equipment's Twitter handle.

### Example 8

In example 5, the message is converted to an email, and the email is sent to a list of email addresses by email software residing on the computer.

### Example 9

In example 5, the equipment is fermenters or bioreactors and associated computer.

### Example 10

In example 5, the equipment is an HPLC, a UPLC, a UHPLC or similar analytical chemistry equipment, and associated computer.

The advantages of this invention include, without limitation, live notifications containing information about the run. Individuals and/or companies who outsource projects involving ÄKTA™ and UNICORN™ systems will quickly know valuable information about the system(s). This reduces a great deal of worry and increases communication transparency. Valuable time is saved between the two parties due to a reduction in phone calls and/or emails. For individuals and/or companies who utilize the invention for personal use, the invention allows the user(s) to focus on other tasks knowing this invention is monitoring the UNICORN™ and ÄKTA™ system. This, in turn, increases productivity and decreases stress.

Disclosed is software that is able to detect a signal being passed from equipment to a computer, capture that signal and turn it into a message that is transmitted to an end user. The message is a SMS or text message. The message is an email. The message is transmitted via the internet. There are one or multiple users.

Also disclosed is software that is comprised of an event processor function, a trailer function, a parser function and a messaging function, that detects a signal being passed from equipment to a computer, captures the signal and turns it into a message that is transmitted to one or more end users. The messaging function is provided by a third party. The event is generated as a bit or series of bits of known addresses. The event is generated by periodically reading an event log file. The codes recognized by the trailer function are pre-programmed in the software. The codes recognized by the trailer function are user configurable. The message is comprised of an SMS, an email or via the internet. The disclosed software is part of the operating software for the equipment. The disclosed software is an add-on and runs separately from the operating software for the equipment. The operating system for the computer is Windows based. The operating system for the computer is iOS based. The operating system is Linux based. Software that resides on a Windows based computer that interacts with UNICORN software written for an AKTA preparative chromatography system, and generates messages for one or more end users.

The event is generated by monitoring an event log file. The message is an SMS. The SMS is generated by third party software. The codes for the events are pre-programmed. The codes for the events are user configurable. Software is disclosed that monitors a fermenter or bioreactor, detects events, parses them and exports them as a message to an end user or users. Software is disclosed that monitors an HPLC or variant thereof, detects events, parses them and exports them as a message to an end user or users.

In broad embodiment, the invention is a text message notification system.

While the description of the invention is presently considered the best version, one of ordinary skill will recognize the potential for variations of the invention. Therefore, the invention should not be limited by the present description and embodiment. Instead, its limitations include all embodiments within the scope of the invention.

What is claimed:

1. Software that is able to detect a signal being passed from equipment to a computer, capture that signal and turn it into a message that is transmitted to an end user.
